(19) United States
(12) Patent Application Publication
(10) Pub. No.: US 2016/0213201 A1
(43) Pub. Date: Jul. 28, 2016

(54) FOOD CRUMB CATCHING SYSTEM

(71) Applicants: David Ku, Fairfield, NJ (US); Ta Ching Ku, Livingston, NJ (US)

(72) Inventors: David Ku, Fairfield, NJ (US); Ta Ching Ku, Livingston, NJ (US)

(21) Appl. No.: 14/603,514

(22) Filed: Jan. 23, 2015

(51) Int. Cl. A47J 47/04; B65D 43/02; B65D 25/04

(52) U.S. Cl. CPC A47J 47/04; B65D 25/04; B65D 43/02

(57) ABSTRACT

A food crumb catching system has a container with a primary enclosed compartment, a second smaller enclosed compartment, and a partition separating the two compartments. The partition has a plurality of spaced-apart openings to allow food crumbs located in the larger compartment to flow through into the second compartment. Removable lids are provided for each of the compartments. Another embodiment of the invention discloses a slideable arm. member located between the first compartment and the smaller second compartment. The arm member also has a plurality of openings and can be slid to a position where all food and its crumbs remain in the first compartment, to a second position in Which the arm member openings are aligned with the partition openings to allow the crumbs to fall into the second compartment.

### BACKGROUND OF THE INVENTION

There is a category of dry foodstuffs which, over time and before they are consumed, create crumbs and food particles within their original packaging. These crumbs are eventually discarded. Examples of such foods include dry cereals, cookies, and snack foods like crackers, pretzels, and potato chips. The storage of these foods in airtight containers is a common way to maintain the food's freshness, once their original packaging is open. However, while in the containers, the unwanted crumbs or particles become disbursed around and between the food. The crumbs/particles not only serve to prevent the accurate measurement of dry food, when necessary, but they also become an annoyance when removing the food from the storage container and during the cleanup of the container.

### SUMMARY OF THE INVENTION

It is thus the object of the present invention to provide a food crumb catching system which efficiently and easily sifts food crumbs and food particles from dry food stored in a container and separates them from the food, within the same container, for removal.

These and other objects are accomplished by the present invention, a food crumb catching system which comprises a container having a primary enclosed compartment, a second smaller enclosed compartment, and a partition separating the two compartments. The partition has a plurality of spaced-apart openings to allow food crumbs located in the larger compartment to flow through into the second compartment. Removable lids are provided for each of the compartments. Another embodiment of the invention discloses a slideable arm member located between the first compartment and the smaller second compartment. The arm member also has a plurality of openings and can be slid to a position where all food and its particles remain in the first compartment, to a second position in which the arm member openings are aligned with the partition openings to allow the crumbs to fall into the second compartment.

The novel features which are considered as characteristic of the invention are set forth in particular in the appended claims. The invention, itself, however, both as to its design, construction. and use, together with additional features and advantages thereof, are best understood upon review of the following detailed description with reference to the accompanying drawings.

### BRIEF DESCRIPTION OF THE DRAWINGS

FIG. 1 is a top perspective view of the food crumb catching system of the present invention, including its container.

FIG. 2 is a bottom perspective view of the food crumb catching system, including its container.

FIG. 3 is another bottom perspective view of the container shown in FIG. 1, with its bottom lid removed.

FIG. 4 is a cross-sectional perspective view of the container shown in FIG. 1.

FIG. 5 is another cross-sectional view of the container shown in FIG. 1, depicting food. particles being accumulated in the lower compartment of the container.

FIG. 6 is a top perspective view of a second embodiment of the food crumb catching system of the present invention.

FIG. 7 is a bottom perspective view of the food crumb catching system, including its container, showing components of the system.

FIG. 8 is a top perspective view of a third embodiment of the food crumb catching system of the present invention.

FIG. 9 is a top perspective internal view of the container of the system shown in FIG. 8 with the partition openings covered.

FIG. 10 is a view similar to FIG. 9, with the partition openings uncovered.

FIG. 11 is a view similar to FIGS. 9 and 10, showing the partition openings partially covered.

FIG. 12 is a top perspective view of a fourth embodiment of the food crumb catching system, including its container.

FIG. 13 is a cross-sectional perspective view of the container shown in FIG. 12.

### DETAILED DESCRIPTION OF THE INVENTION

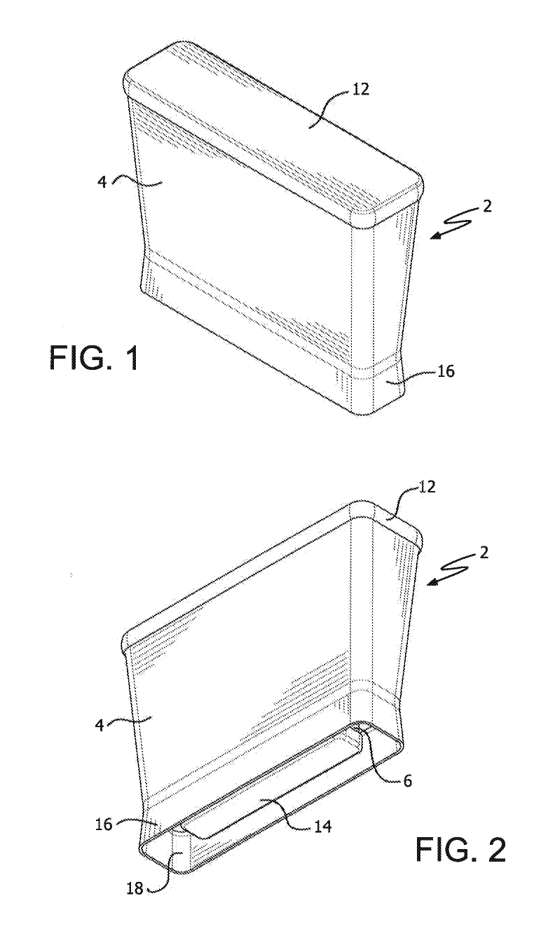

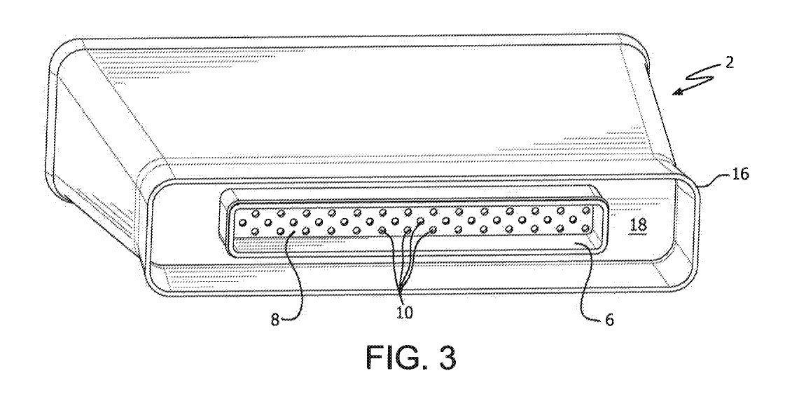

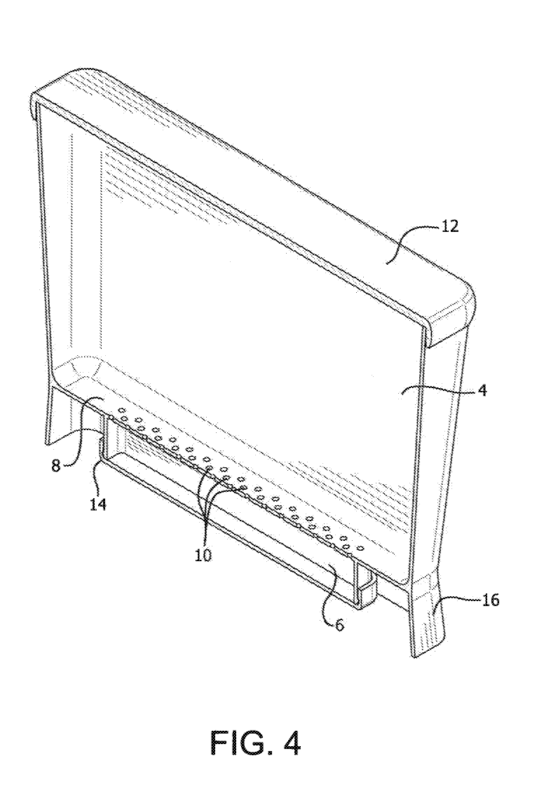

The food crumb catching system of the invention, shown in FIGS. 1-4, comprises container 2 having primary food storage compartment 4, smaller food crumb receiving compartment 6 below the primary compartment, and partition 8. Smaller food crumb receiving compartment 6 extends down from partition 8. Compartment 6 is less than the length of partition 8 and less than the width of primary compartment 4. Partition 8 has a plurality of spaced apart through openings 10 extending the length of smaller compartment 6. Removable lid 12 provides access to primary compartment 4 and removable lid 14 provides access to smaller compartment 6. Skirt 16 surrounds the lowest section of container 2, creating circumscribed space 18 around smaller compartment 6, which allows for ready access to lid 14.

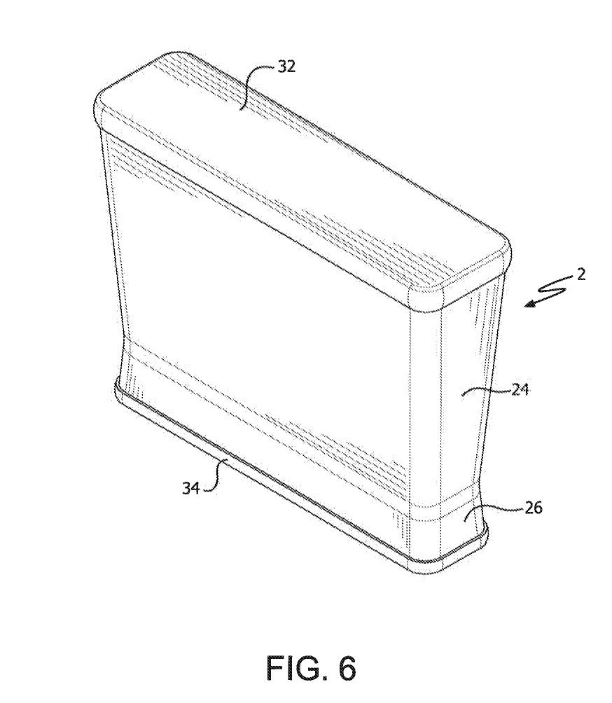

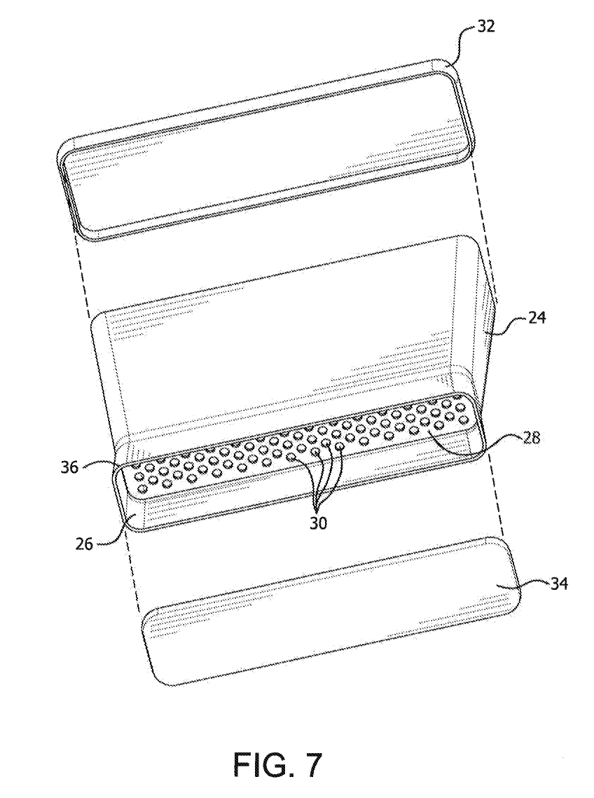

FIGS. 6-7, showing a second embodiment of the invention, comprises container 20 having primary food storage compartment 24 and smaller food particle receiving compartment 26 extending the length of and below the primary compartment Skirt 36 circumscribes compartment 26. Partition 28 separates the two compartments. Partition 28 has a plurality of spaced apart through openings 30 extending the length of the partition. Removable lid 32 provides access to primary compartment 24 and removable lid 34 provides access to smaller compartment 26.

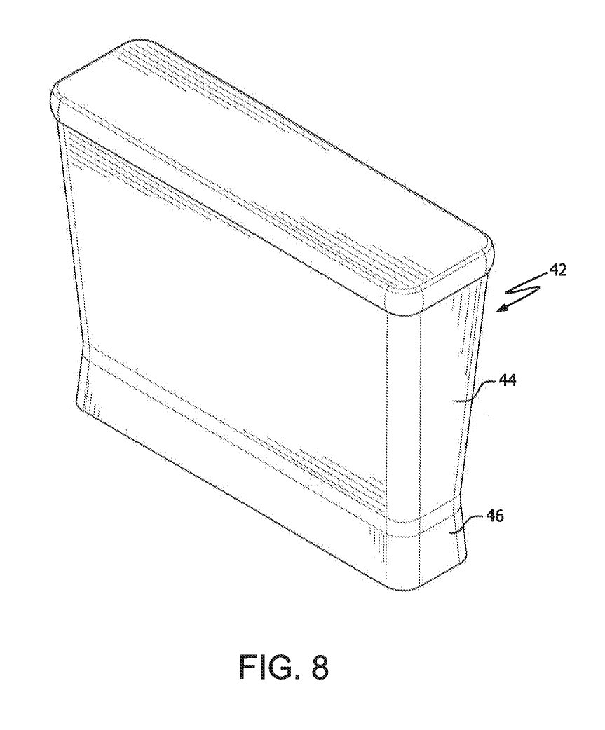

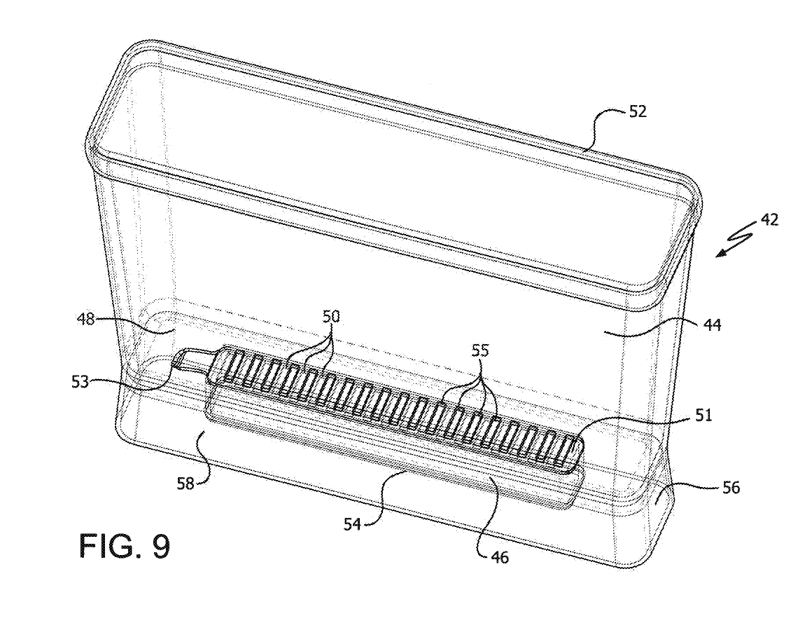

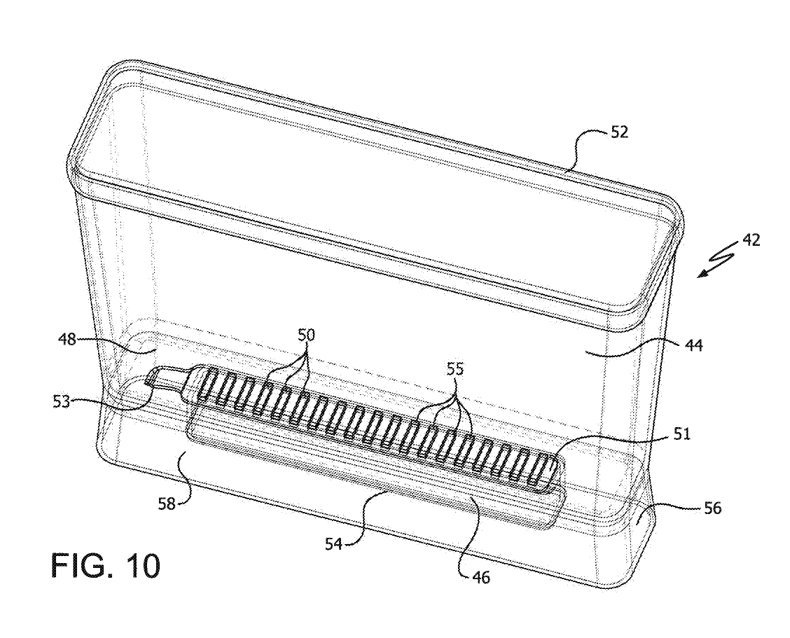

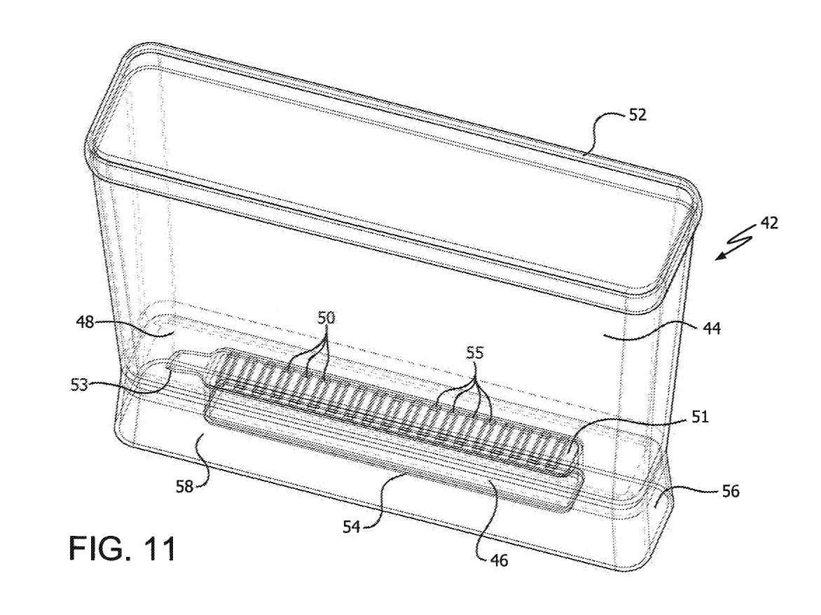

FIGS. 8-11 show a third embodiment of the invention, which, similar to the embodiment in FIGS. 1-5, comprises container 42 having primary food storage compartment 44 and smaller food particle receiving compartment 46 beneath the primary compartment and extending down from and the length of partition 48. Partition 48 has a plurality of openings 50 aligned parallel to each other and extending the length of smaller compartment 46. Arm member 51 is slideably located between partition 48 and smaller compartment 46. Arm member 51 has tab handle 53 and a plurality of openings 55 having the same size as and being spaced the same distance apart from each other as openings 50 through partition 48 are to each other. Thus, arm member 51 can be slid between a first position, shown in FIG. 9, in which its openings 55 are located over the solid surfaces directly between openings 50 of partition 48, thereby effectively covering up openings 50, to a second position, shown in FIG. 10, in which openings 50 and 55 are aligned over each other to uncover openings 50. Arm member 51 can also be slid to various positions in between the covered and uncovered positions. For example, FIG. 11 shows openings 50 partially uncovered.

Removable lid 52 provides access to primary compartment 44 and removable lid 54 provides access to smaller compartment 46. Skirt 56 surrounds the lowest section of container 42, creating circumscribed space 58 around smaller compartment 56, which provides ready access to lid 54 and arm member 51.

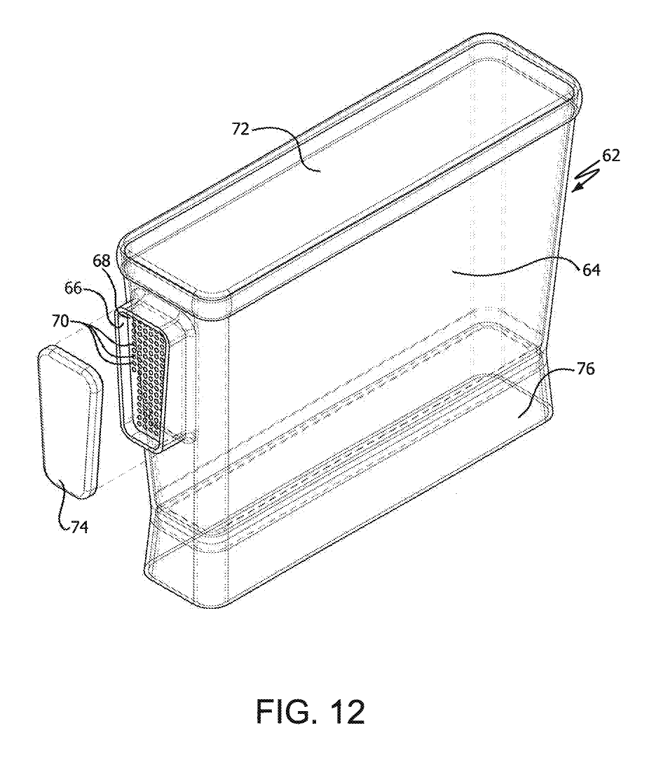

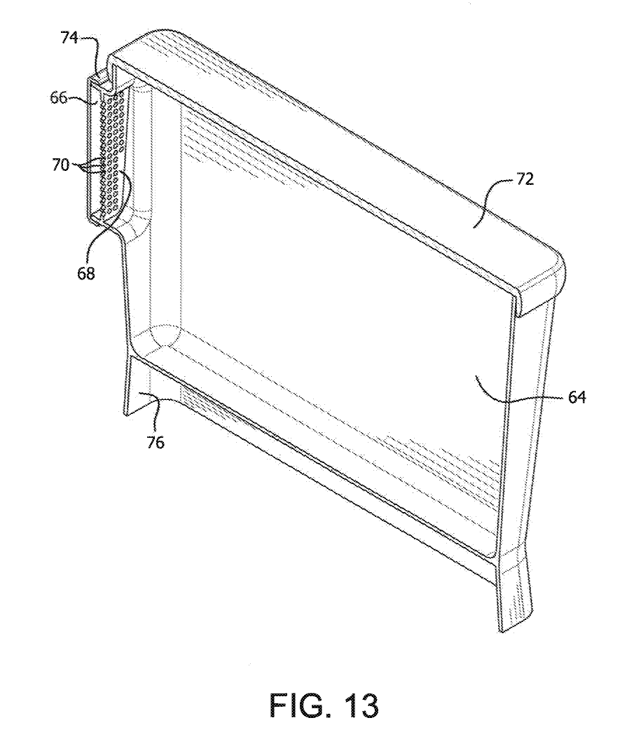

FIGS. 12-13, a fourth embodiment of the invention, comprises container 62 having primary food storage compartment 64 and smaller food particle receiving compartment 66, located laterally of the primary compartment. Partition 68, with a plurality of openings 70, separate compartments 64 and 66. Removable lid 72 provides access to primary compartment 64 and removable lid 74 provides access to smaller compartment 66. Skirt 76 supports container 62.

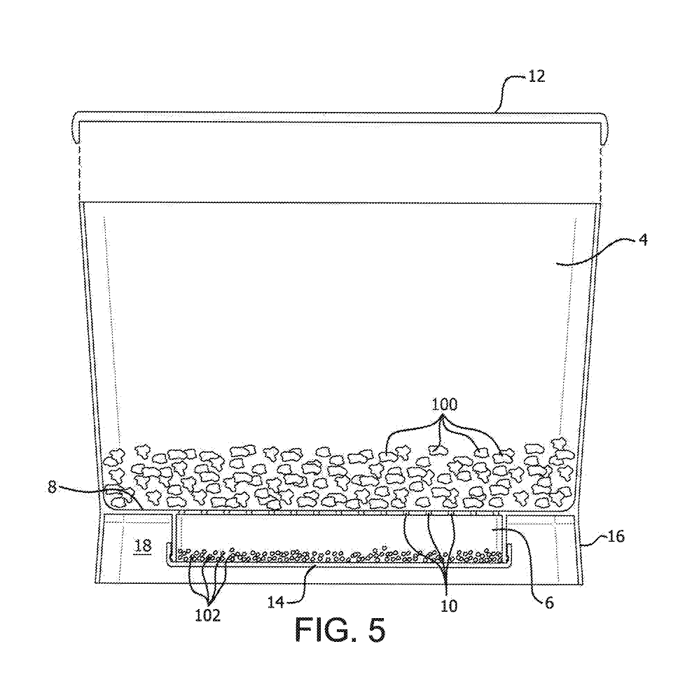

In use, food such as, dry cereal, 100, having crumbs or particles 102, are housed in primary food storage compartments 4, 24, 44, and 64 of containers 2, 22, 42, and 62, of the disclosed embodiments. See, for example, the depiction of food 100 and crumbs 102 in FIG. 5. It is appreciated that, as to the embodiments shown in FIGS. 1-7, food crumbs 102 located in primary compartments 4 and 24 which are smaller than openings 10 and 30, will fall through the openings into and accumulate within smaller compartments 6 and 26. Upon removal of lids 14 and 34, these crumbs 102 will fall from containers 2 and 22, without disturbing food 100 in primary compartments 4 and 24.

In like manner, in the embodiment shown in FIGS. 12-13, food crumbs 102 located in primary compartment 64 which are smaller than openings 70, will fall through the openings, when container 62 is tipped to the side. Food crumbs 102 will accumulate within smaller compartment 66. Upon removal of lid 74, these crumbs will fall from container 62, without disturbing food 100 in primary compartment 64.

The embodiment shown in FIGS. 8-11 will allow storage of food 100 and food crumbs 102 in primary compartment 44 of container 42. To maintain all food and its crumbs within primary compartment 44, arm member 51 is positioned such that its openings 55 are aligned over the solid surfaces of partition 48, located between partition openings 50. In this position, shown in FIG. 9, partition openings 50 are fully covered by arm member 51. By sliding arm member such that partition openings 50 are aligned over arm member openings 55, shown in FIG. 10, openings 50 are uncovered and food crumbs from primary compartment 44 are free to flow through the openings into smaller compartment 46. Upon removal of lid 44, these particles will fall from container 42 without disturbing food 100 in primary compartment 44.

The food crumb catching system described herein can be used to sift crumbs from foods like dry cereals, cookies, crackers, pretzels, chips, or any like dry food stuffs which routinely create crumbs.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A food crumb catching system for isolating food crumbs, said system comprising:
a container having:
a primary enclosed compartment;
a second enclosed compartment, smaller than and adjacent to the primary compartment;
a partition separating the primary and second compartments, said partition having a plurality of spaced-apart openings, whereby food crumbs located in the primary compartment fall through the openings into the second compartment;
a first removable lid which, when removed, allows access to the primary compartment; and
a second removable lid which, when removed, allows access to the second compartment.

2. The system as in claim 1 wherein the second compartment is located below the primary compartment.

3. The system as in claim 1 wherein the partition is located below the primary compartment and above the second compartment.

4. The system as in claim 2 wherein the partition is located below the primary compartment and above the second compartment.

5. The system as in claim 1 wherein the partition comprises an arm member slideable to at least two positions, whereby when the arm member is in a first position, the openings are covered up and when the arm member is in a second position, the openings are uncovered to allow crumbs in the primary compartment to flow through the openings into the second compartment.

6. The system as in claim 5 wherein the arm member has a plurality of openings, whereby in the second position, the arm member openings are aligned over the partition openings to allow food crumbs in the primary compartment to flow through all the openings into the second compartment and, in the first position, the arm member openings are slid away from the partition openings such that the arm member covers up the partition openings.

7. The system as in claim 5 wherein the second compartment is located below the primary compartment.

8. The system as in claim 5 wherein the partition is located below the primary compartment and above the second compartment.

9. The system as in claim 7 wherein the partition is located below the primary compartment and above the second compartment.

10. The system as in claim 1 wherein the second compartment is located laterally of the primary compartment.

11. The system as in claim 10 wherein the partition is located between the primary compartment and second compartment.

12. The system as in claim 5 wherein the arm member is slideably located between the partition and the second compartment.

13. The system as in claim 12 wherein the aim member comprises a plurality of openings.
